(19) United States
(12) Patent Application Publication
(10) Pub. No.: US 2025/0214412 A1
(43) Pub. Date: Jul. 3, 2025

(54) RADIATOR ASSEMBLY FOR A CLOSED-CYCLE ENGINE

(71) Applicant: Hyliion Holdings Corp, Cedar Park, TX (US)

(72) Inventors: Joshua Tyler Mook, Cincinnati, OH (US); Michael Robert Notarnicola, Cincinnati, OH (US)

(21) Appl. No.: 18/397,564

(22) Filed: Dec. 27, 2023

(51) Int. Cl. B60K 11/04

(52) U.S. Cl. CPC B60K 11/04

(57) ABSTRACT

A radiator assembly for a closed-cycle engine of a vehicle includes a first radiator and a second radiator. The first radiator is mounted in a first position and the second radiator is mounted in a second position. The first and second positions are different. Further, the second position is defined by the second radiator being positioned at a non-zero angle with respect to the first position of the first radiator.

### FIELD

The present disclosure relates generally to vehicles having a closed-cycle engine, and more particularly to a radiator assembly for a closed-cycle engine that can be incorporated into a vehicle.

### BACKGROUND

Large vehicles may be used to efficiently transport cargo. Large, wheeled vehicles pull trailers to transport large volumes of cargo on land, wherein the combination of the vehicle and the trailer can weigh between 30,000 pounds up to 140,000 pounds for a tandem loaded trailer. These vehicles may be referred to as “powered semi-tractors”, “semi-tractors”, “semis”, or “trucks.” Trucks may be used on roads such as highways and in urban areas but may also be used on unimproved roads or uneven terrain. In a traditional truck with an internal combustion engine, the internal combustion engine may be sized in the range of 15 liters to provide enough power to propel the vehicle and the trailer.

Such vehicles may be designed with unique configurations capable of integrating one of several different types of engines, such as a closed-cycle engine, to generate electric power for charging an array of batteries under a plurality of operating conditions.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a side view of an embodiment of a wheeled vehicle capable of transporting cargo over an extended range according to the present disclosure;

FIG. 2 illustrates a detailed, top view of an embodiment of a wheeled vehicle capable of transporting cargo over an extended range according to the present disclosure;

FIG. 3 illustrates a schematic diagram of an embodiment of the vehicle depicted in FIGS. 1 and 2;

FIG. 4 illustrates a cross sectional view of an embodiment of a closed-cycle engine for a vehicle according to the present disclosure;

FIG. 5 illustrates a front view of an embodiment of a wheeled vehicle capable of transporting cargo over an extended range according to the present disclosure, particularly illustrating a radiator assembly arranged in a compartment of the vehicle;

FIG. 6 illustrates a perspective view of an embodiment of a wheeled vehicle capable of transporting cargo over an extended range according to the present disclosure, particularly illustrating a radiator assembly arranged in a compartment of the vehicle;

FIG. 7 illustrates a partial, perspective view of an embodiment of a wheeled vehicle capable of transporting cargo over an extended range and having a hood removed to illustrate components below the hood according to the present disclosure, particularly illustrating a radiator assembly mounted to a chassis of the vehicle;

FIG. 8 illustrates a simplified, schematic diagram of an embodiment of a radiator assembly of a vehicle according to the present disclosure; and

FIG. 9 illustrates a flow diagram of an embodiment of a method for cooling a closed-cycle engine of a vehicle according to the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

Generally, the present disclosure is directed to a radiator assembly for a vehicle having a first radiator and an angled, second radiator. In particular embodiments, the radiator assembly is mounted to a chassis in a front compartment of the vehicle, e.g., below a hood of the vehicle. Further, the vehicle includes a closed-cycle engine a having plurality of cylinder-piston assemblies mounted to the chassis aft of the radiator assembly, e.g., outside of and aft of the compartment. Moreover, the first radiator is mounted in a first position and the second radiator is mounted in a second position, with the first and second positions being different. In an embodiment, for example, the second position is defined by the second radiator being positioned at a non-zero angle with respect to the first position of the first radiator. As such, the angled, second radiator has a clear path to ground, which reduces a power demand of the radiator assembly.

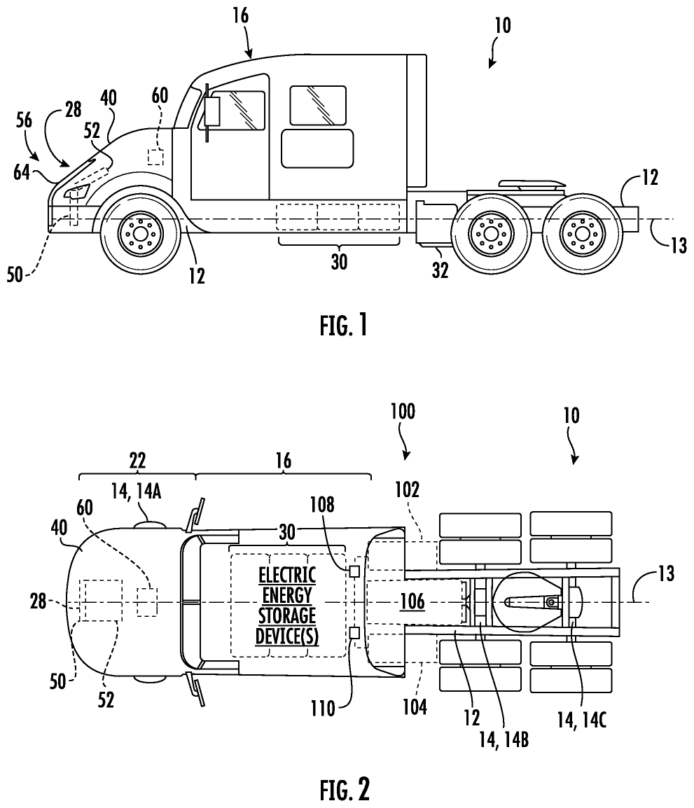

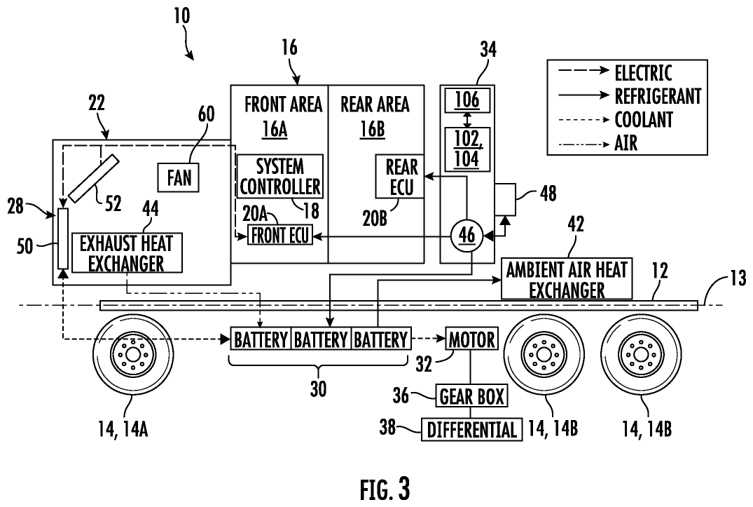

Referring now to the drawings, FIGS. 1-3 illustrate various views of an embodiment of a wheeled vehicle 10 along a longitudinal axis 13 according to the present disclosure. In particular, FIGS. 1 and 2 depict side and top partial views of the wheeled vehicle 10, respectively, such as a truck or semi-tractor used to pull one or more trailers with cargo. As shown generally in FIGS. 1-3, components of the vehicle 10 may include, but are not limited to, a chassis 12, which may support multiple axles 14, a cab 16, a compartment 22 containing a radiator assembly 28, an engine assembly 100 having one or more closed-cycle engines 102, 104 mounted to the chassis 12 aft of the radiator assembly 28, e.g., outside of the compartment 22, a hood 40 for accessing the compartment 22, an array of energy storage devices 30 (e.g., batteries), and a motor/generator 32 coupled to at least one of the axles 14. Moreover, as shown particularly in FIG. 2, the one or more closed-cycle engines 102, 104 may be fluidly coupled with one or more fuel tanks 106. Furthermore, as shown in FIG. 2, the vehicle 10 may be equipped with one or more power converters 108, 109 coupled to the closed-cycle engines 102, 104 and the array of energy storage devices 30.

In an embodiment, the chassis 12 may be formed with two frame members such as C-channels arranged parallel to each other. Further, in an embodiment, as shown in FIGS. 2 and 3, the axles 14 coupled to the chassis 12 may include a front axle 14A located under the compartment 22 and rear axles 14B and 14C located behind the cab 16.

Moreover, in an embodiment, the compartment 22 includes mounts for supporting the radiator assembly 28. Thus, the radiator assembly 28 may be positioned at the front of the compartment 22 for cooling the closed closed-cycle engines 102, 104. As such, in an embodiment, coolant, such as glycol or some other anti-freeze liquid, may be circulated through the radiator assembly 28 and the closed closed-cycle engines 102, 104 to remove heat from the closed closed-cycle engines 102, 104 and transfer the heat to the ambient air as further described herein.

Referring particularly to FIG. 3, the cab 16 may further include a system controller 18 for monitoring systems on the vehicle 10 and one or more environmental control units (ECU) 20 having air conditioning and heating options. As depicted in FIG. 3, a front area 16A of the cab 16 may have a front ECU 20A for managing cab temperatures and a rear area 16B of the cab 16 may have a rear ECU 20B for managing rear area temperatures. In such embodiments, the front and rear ECUs 20A, 20B may be fluidly coupled to a compressor 46 and a refrigerant heat exchanger 48 as part of an air conditioning system for the cab 16 and a thermal management system for the energy storage devices 30.

In an embodiment, as shown in FIG. 3, the vehicle 10 may further include an ambient air heat exchanger 42 for heat exchange between the energy storage devices 30 and the ambient air and an exhaust heat exchanger 44 for extracting heat from exhaust gases to heat the energy storage devices 30.

Further, as shown in FIGS. 1-3, an array of energy storage devices 30 may be positioned in various locations on the vehicle 10. In some embodiments, as shown, the energy storage devices 30 may be located on the chassis 12. In some embodiments, the energy storage devices 30 may be located between, under, or around the rails of the chassis 12. Moreover, in an embodiment, the array of energy storage devices 30 may be connected in series, parallel or some combination. Thus, in an embodiment, electric power generated by the generator 26 may be used to charge the array of energy storage devices 30.

Referring to FIGS. 2 and 3, the motor/generator 32 may be coupled to at least one of the axles 14. For example, in some embodiments, the motor/generator 32 may be integrated with one of the axles 14 as an e-axle configuration or located in a hub of a wheel coupled to one of the axles 14 as a hub motor/generator configuration. Moreover, embodiments of the vehicle 10 may include the motor/generator 32 coupled to gearboxes or differentials. For example, as depicted in FIG. 3, the motor/generator 32 may be coupled to a three-speed centralized gearbox 36 with a two-speed rear differential 38 to provide six discrete gear ratios. In some embodiments, the vehicle 10 may be configured with a plurality of motor/generators 32, with a motor/generator 32 coupled to each wheel or pair of wheels. Moreover, as shown in FIGS. 2 and 3, behind the cab 16, the rear pack 34 may be configured to hold one or more fuel tanks 106 for use by closed closed-cycle engines 102, 104.

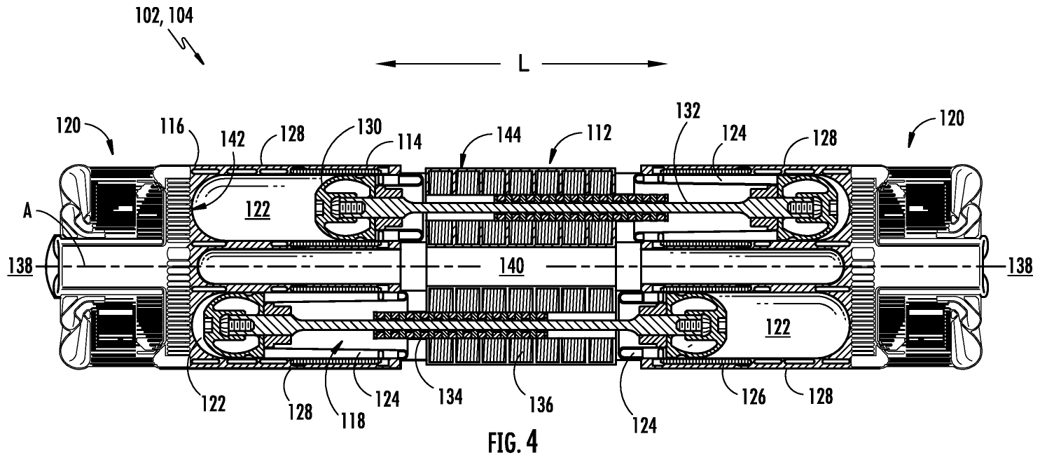

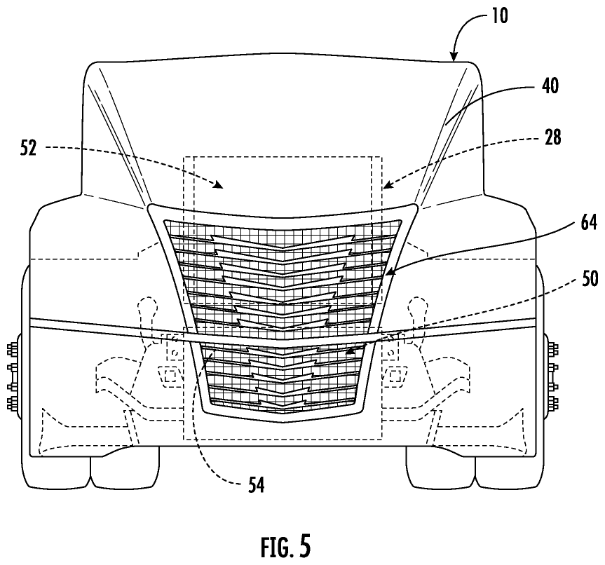

Referring now to FIG. 4, a cross-sectional view of an embodiment of one of the closed-cycle engines 102, 104 along longitudinal axis A and operably coupled to a load device 112 is illustrated according to the present disclosure. In an embodiment, the closed-cycle engine 102, 104 contains a substantially fixed mass of an engine working fluid to which and from which thermal energy is exchanged at a respective cold side heat exchanger 114 and a hot side heat exchanger 116. In an embodiment, the engine working fluid is helium. In other embodiments, the engine working fluid may include air, nitrogen, hydrogen, helium, or any appropriate compressible fluid, or combinations thereof.

In still various embodiments, any suitable engine working fluid may be utilized in accordance with the present disclosure. In exemplary embodiments, the engine working fluid may include a gas, such as an inert gas. For example, a noble gas, such as helium may be utilized as the engine working fluid. Exemplary working fluids preferably are inert, such that they generally do not participate in chemical reactions such as oxidation within the environment of the closed-cycle engine 102, 104. Exemplary noble gasses include monoatomic gases such as helium, neon, argon, krypton, or xenon, as well as combinations of these. In some embodiments, the engine working fluid may include air, oxygen, nitrogen, or carbon dioxide, as well as combinations of these. In still various embodiments, the engine working fluid may be liquid fluids of one or more elements described herein, or combinations thereof. It should further be appreciated that various embodiments of the engine working fluid may include particles or other substances as appropriate for the engine working fluid.

In various embodiments, the load device 112 is a mechanical work device or an electric machine. In an embodiment, the load device 112 is a pump, compressor, or other work device. In another embodiment, the load device 112 as an electric machine is configured as a generator producing electric energy from movement of a piston assembly 118 at the closed-cycle engine 102, 104. In still another embodiment, the electric machine is configured as a motor providing motive force to move or actuate the piston assembly 118, such as to provide initial movement (e.g., a starter motor). In still various embodiments, the electric machine defines a motor and generator or other electric machine apparatus such as described further herein.

A heater body 120 is thermally coupled to the closed-cycle engine 102, 104. The heater body 120 may generally define any apparatus for producing or otherwise providing a heating working fluid such as to provide thermal energy to the engine working fluid. Various embodiments of the heater body 120 are further provided herein. Exemplary heater bodies 120 may include, but are not limited to, a combustion or detonation assembly, an electric heater, a nuclear energy source, a renewable energy source such as solar power, a fuel cell, a heat recovery system, or as a bottoming cycle to another system. Exemplary heater bodies 120 at which a heat recovery system may be defined include, but are not limited to, industrial waste heat generally, gas or steam turbine waste heat, nuclear waste heat, geothermal energy, decomposition of agricultural or animal waste, molten earth or metal or steel mill gases, industrial drying systems generally or kilns, or fuel cells. The exemplary heater body 120 providing thermal energy to the engine working fluid may include all or part of a combined heat and power cycle, or cogeneration system, or power generation system generally.

In still various embodiments, the heater body 120 is configured to provide thermal energy to the engine working fluid via a heating working fluid. The heating working fluid may be based, at least in part, on heat and liquid, gaseous, or other fluid provided by one or more fuel sources and oxidizer sources providing a fuel and oxidizer. In various embodiments, the fuel includes, but is not limited to, hydrocarbons and hydrocarbon mixtures generally, “wet” gases including a portion of liquid (e.g., humid gas saturated with liquid vapor, multiphase flow with approximately 10% liquid and approximately 90% gas, natural gas mixed with oil, or other liquid and gas combinations, etc.), petroleum or oil (e.g., Arabian Extra Light Crude Oil, Arabian Super Light, Light Crude Oil, Medium Crude Oil, Heavy Crude Oil, Heavy Fuel Oil, etc.), natural gas (e.g., including sour gas), biodiesel condensate or natural gas liquids (e.g., including liquid natural gas (LNG)), dimethyl ether (DME), distillate oil #2 (DO2), ethane (C₂), methane, high H₂ fuels, fuels including hydrogen blends (e.g., propane, butane, liquefied petroleum gas, naphtha, etc.), diesel, kerosene (e.g., jet fuel, such as, but not limited to, Jet A, Jet A-1, JP1, etc.), alcohols (e.g., methanol, ethanol, etc.), synthesis gas, coke over gas, landfill gases, etc., or combinations thereof.

In various embodiments, the hot side heat exchanger 116 outputs thermal energy to the engine working fluid at an expansion chamber 122 of the closed-cycle engine 102, 104. The hot side heat exchanger 116 is positioned at the expansion chamber 122 of the engine in thermal communication with the heater body 120. In other embodiments, the hot side heat exchanger 116 may be separate from the heater body 120, such that the heating working fluid is provided in thermal communication, or additionally, in fluid communication with the hot side heat exchanger 116. In particular embodiments, the hot side heat exchanger 116 is positioned in direct thermal communication with the heater body 120 and the expansion chamber 122 of the engine 102, 104 such as to receive thermal energy from the heater body 120 and provide thermal energy to the engine working fluid within the closed-cycle engine 102, 104.

In still various embodiments, the heater body 120 may include a single thermal energy output source to a single expansion chamber 122 of the engine. As such, the closed-cycle engine 102, 104 may include a plurality of heater assemblies each providing thermal energy to the engine working fluid at each expansion chamber 122. In other embodiments, such as depicted in regard to FIG. 4, the heater body 120 may provide thermal energy to a plurality of expansion chambers 122 of the closed-cycle engine 102, 104.

The closed-cycle engine 102, 104 further includes a chiller assembly, such as chiller assembly 126 further described herein. The chiller assembly 126 is configured to receive and displace thermal energy from a compression chamber 124 of the closed-cycle engine 102, 104. Further, in an embodiment, the cold side heat exchanger 114 is thermally coupled to the compression chamber 124 of the closed cycle engine 102, 104 and the chiller assembly 126. In one embodiment, the cold side heat exchanger 114 and a piston body 128 defining the compression chamber 124 of the closed-cycle engine 102, 104 are together defined as an integral, unitary structure. In still various embodiments, the cold side heat exchanger 114, at least a portion of the piston body 128 defining the compression chamber 124, and at least a portion of the chiller assembly 126 together define an integral, unitary structure.

In various embodiments, the chiller assembly 126 is a bottoming cycle to the closed-cycle engine 102, 104. As such, the chiller assembly 126 is configured to receive thermal energy from the closed-cycle engine 102, 104. The thermal energy received at the chiller assembly 126, such as through a cold side heat exchanger 114, or a cold side heat exchanger 114 further herein, from the closed-cycle engine 102, 104 is added to a chiller working fluid at the chiller assembly 126. In various embodiments, the chiller assembly 126 defines a Rankine cycle system through which the chiller working fluid flows in closed loop arrangement with a compressor. In some embodiments, the chiller working fluid is further in closed loop arrangement with an expander. In various embodiments, the cold side heat exchanger 114 may include a condenser or radiator. The cold side heat exchanger 114 is positioned downstream of the compressor and upstream of the expander and in thermal communication with the compression chamber 124 of the closed-cycle engine 102, 104. In various embodiments, the cold side heat exchanger 114 may generally define an evaporator receiving thermal energy from the closed-cycle engine 102, 104.

Various embodiments of the closed-cycle engine 102, 104 include control systems and methods of controlling various sub-systems disclosed herein, such as, but not limited to, the fuel source, the oxidizer source, the cooling fluid source, the heater body 120, the chiller assembly 126, and the load device 112, including any flow rates, pressures, temperatures, loads, discharges, frequencies, amplitudes, or other suitable control properties associated with the closed-cycle engine 102, 104.

In an embodiment, the control system can control the closed-cycle engine 102, 104 and its associated balance of plant to generate a temperature differential, such as a temperature differential at the engine working fluid relative to the heating working fluid and the chiller working fluid. Thus, the closed-cycle engine 102, 104 defines a hot side, such as at the expansion chamber 122, and a cold side, such as at the compression chamber 124. The temperature differential causes free piston assemblies 118 to move within their respective piston chambers defined at respective piston bodies 128. The movement of pistons 130 within the respective piston bodies 128 causes the electric machine to generate electrical power. The generated electrical power can be provided to the energy storage devices 30 for charging thereof. The control system monitors one or more operating parameters associated with the closed-cycle engine 102, 104, such as piston movement (e.g., amplitude and position), as well as one or more operating parameters associated with the electric machine, such as voltage or electric current. Based on such parameters, the control system generates control commands that are provided to one or more controllable devices of the closed-cycle engine 102, 104. The controllable devices execute control actions in accordance with the control commands. Accordingly, the desired output of the closed-cycle engine 102, 104 can be achieved.

Referring still to FIG. 4, each piston assembly 118 is positioned within a volume or piston chamber defined by a wall defining the piston body 128. The volume within the piston body 128 is separated into a first chamber, or hot chamber, or expansion chamber 122 and a second chamber, or cold chamber (relative to the hot chamber), or compression chamber 124 by a piston 130 of the piston assembly 118. The expansion chamber 122 is positioned thermally proximal to the heater body 120 relative to the compression chamber 124 thermally distal to the heater body 120. The compression chamber 124 is positioned thermally proximal to the chiller assembly 126 relative to the expansion chamber 122 thermally distal to the chiller assembly 126.

In various embodiments, the piston assembly 118 defines a double-ended piston assembly 118 in which a pair of pistons 130 is each coupled to a connection member 132. The connection member 132 may generally define a rigid shaft or rod extended along a direction of motion of the piston assembly 118. In other embodiments, the connection members 132 includes one or more springs or spring assemblies, such as further provided herein, providing flexible or non-rigid movement of the connection member 132. In still other embodiments, the connection member 132 may further define substantially U- or V-connections between the pair of pistons 130.

Each piston 130 is positioned within the piston body 128 such as to define the expansion chamber 122 and the compression chamber 124 within the volume of the piston body 128. The load device 112 is operably coupled to the piston assembly 118 such as to extract energy therefrom, provide energy thereto, or both. The load device 112 defining an electric machine is in magnetic communication with the closed closed-cycle engine 102, 104 via the connection member 132. In various embodiments, the piston assembly 118 includes a dynamic member 134 positioned in operable communication with a stator assembly 136 of the electric machine. The stator assembly 136 may generally include a plurality of windings wrapped circumferentially relative to the piston assembly 118 and extended along a lateral direction L. In one embodiment, such as depicted in regard to FIG. 4, the dynamic member 134 is connected to the connection member 132. The electric machine may further be positioned between the pair of pistons 130 of each piston assembly 118. Dynamic motion of the piston assembly 118 generates electricity at the electric machine. For example, linear motion of the dynamic member 134 between each pair of chambers defined by each piston 130 of the piston assembly 118 generates electricity via the magnetic communication with the stator assembly 136 surrounding the dynamic member 134.

Referring still to FIG. 4, in various embodiments, the hot side heat exchanger 116 may further define at least a portion of the expansion chamber 122. In one embodiment, such as further described herein, the hot side heat exchanger 116 defines a unitary or monolithic structure with at least a portion of the piston body 128, such as to define at least a portion of the expansion chamber 122. In some embodiments, the heater body 120 further defines at least a portion of the hot side heat exchanger 116, such as to define a unitary or monolithic structure with the hot side heat exchanger 116, such as further described herein.

Furthermore, as shown, the closed-cycle engine 102, 104 defines an outer end 138 and an inner end 140 each relative to a lateral direction L. The outer ends 138 define laterally distal ends of the closed-cycle engine 102, 104 and the inner ends 140 define laterally inward or central positions of the closed-cycle engine 102, 104. In one embodiment, such as depicted in regard to FIG. 4, the heater body 120 is positioned at outer ends 138 of the closed-cycle engine 102, 104. The piston body 128 includes a dome structure 142 at the expansion chamber 122. The expansion chamber dome structure 142 provides reduced surface area heat losses across the outer end 138 of the expansion chamber 122. In various embodiments, the pistons 130 of the piston assembly 118 further include domed pistons 130 corresponding to the expansion chamber 122 dome. The dome structure 142, the domed piston 130, or both may provide higher compressions ratios at the chambers 122, 124, such as to improve power density and output.

In various embodiments, such as depicted in regard to FIG. 4, the load device 112 is positioned at the inner end 140 of the closed-cycle engine 102, 104 between laterally opposing pistons 130. The load device 112 may further include a machine body 144 positioned laterally between the piston bodies 128. The machine body 144 surrounds and houses the stator assembly 136 of the load device 112 defining the electric machine. The machine body 144 further surrounds the dynamic member 134 of the electric machine attached to the connection member 132 of the piston assembly 118.

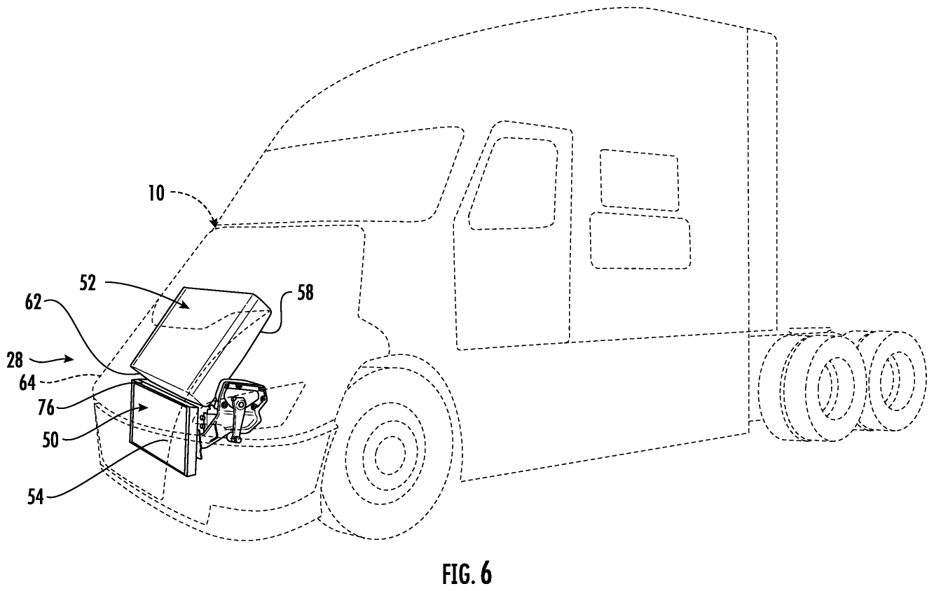

Referring now to FIGS. 5-8, various views of an embodiment of the vehicle 10 having the radiator assembly 28 according to the present disclosure are illustrated. Furthermore, as shown, the vehicle 10 includes the radiator assembly 28 mounted to the chassis 12 and positioned below the hood 40. In addition, as shown in FIGS. 5 and 6, the vehicle 10 includes a grille 64 for receiving an incoming airflow 56 (FIGS. 1 and 5) therethrough so as to cool the radiator assembly 28. Moreover, as shown generally in FIGS. 5-8, the radiator assembly 28 includes a first radiator 50 and a second radiator 52. In addition, as shown, the vehicle 10 includes the one or more closed-cycle engines 102, 104 mounted to the chassis 12 aft of the radiator assembly 28. In particular, as shown in FIG. 2, the closed-cycle engines 102 and 104 are mounted to the sides of the vehicle 10.

Referring back to FIGS. 1-3, the vehicle 10 further includes a fan 60 positioned aft of the first and second radiators 50, 52 and forward of the closed-cycle engines 102, 104 so as to draw air into the first and second radiators 50, 52 and down to the ground 74. For example, in an embodiment, the fan 60 is configured to draw the incoming airflow 56 through the grille 64, across the first radiator 50, across the second radiator 52, and then out of the vehicle 10 directly to the ground 74.

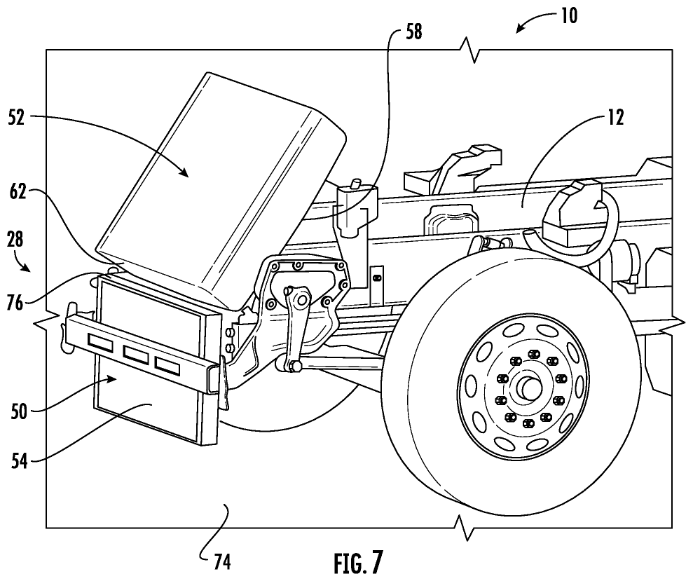

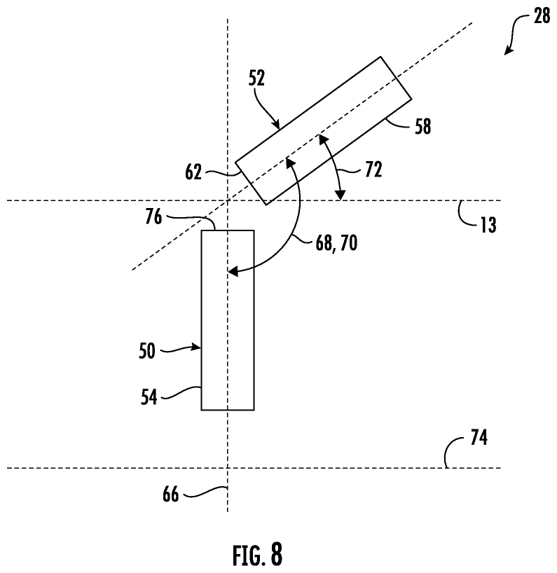

Furthermore, and referring particularly to FIGS. 6 and 7, the first radiator 50 is mounted in a first position and the second radiator 52 is mounted in a second position, with the first and second positions being different. In particular embodiments, for example, as shown generally in FIGS. 5-8, the second position of the second radiator 52 may be defined by the second radiator 52 being positioned at a non-zero angle 68 with respect to the first position of the first radiator 50. Moreover, as shown particularly in FIG. 8, the first position of the first radiator 50 may be defined by the first radiator 50 being positioned parallel to a vertical axis 66 of the vehicle 10. In such embodiments, the second position of the second radiator 52 defines an obtuse angle 70 with respect to the first position of the first radiator 50.

Furthermore, as shown particularly in FIGS. 5-7, the second position may be defined by the second radiator 52 being angled toward the closed-cycle engines 102, 104 of the vehicle 10. In such embodiments, as shown in FIG. 8, the second position of the second radiator 52 may generally extend at an angle 72 with respect to the longitudinal axis 13 of the vehicle 10. For example, as shown, the angle 72 may be about 45-degrees. In further embodiments, the angle 72 may be any suitable angle ranging, e.g., from greater than zero (0) degrees to less than 90 degrees.

In addition, as shown generally in FIGS. 5-8, the second radiator 52 may be positioned higher in the vehicle 10 than the first radiator 50. In addition, as shown in FIGS. 7 and 8, an end 62 of the second radiator 52 is positioned adjacent to a top end 76 of the first radiator 50. Thus, as shown particularly in FIGS. 5 and 6, the second position of the second radiator 52 is configured to provide for the second radiator 52 to generally correspond to an angle of the hood 40. In other words, since the closed-cycle engines 102, 104 are not positioned in the compartment 22, but aft of the compartment 22 on the chassis 12, the compartment 22 has more space to receive the radiator assembly 28 described herein. Thus, the second radiator 52 of the radiator assembly 28 can be angled and the compartment 22 can be shaped to reduce drag of the vehicle 10.

Referring particularly to FIGS. 5 and 7-8, the first radiator 50 further defines a first radiator surface 54. Thus, as shown, the first radiator surface 54 can be arranged to face the incoming airflow 56 in front of the vehicle 10. Similarly, as shown in FIGS. 7 and 8, the second radiator 52 further defines a second radiator surface 58. In such embodiments, the second radiator surface 58 is arranged to face a ground 74 below the vehicle 10 such that the second radiator surface 58 is unobstructed with respect to the ground 74. In an embodiment, such an arrangement allows for the fan 60 to efficiently draw the incoming airflow 56 through the grille 64, across the first and second radiators 50, 52, and then directly out of the vehicle 10 to the ground 74.

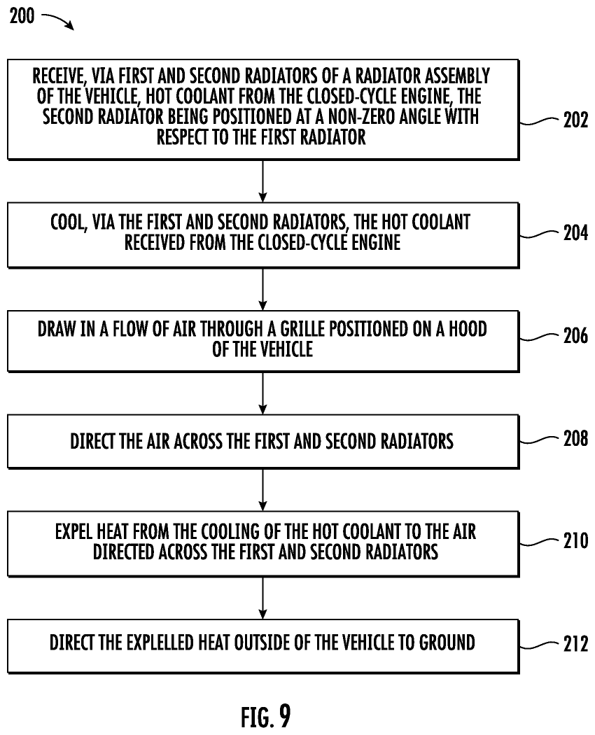

Referring now to FIG. 9, a flow diagram of an embodiment of a method 200 for cooling a closed-cycle engine of a vehicle is illustrated. In general, the method 200 will be described herein with reference to the closed-cycle engine 102, 104 and radiator assembly illustrated in FIGS. 1-8. However, it should be appreciated that the disclosed method 200 may be implemented with any engine having any other suitable configurations. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in numerous ways without deviating from the scope of the present disclosure.

As shown at (202), the method 200 includes receiving, via first and second radiators of a radiator assembly of the vehicle, hot coolant from the closed-cycle engine, the second radiator being positioned at a non-zero angle with respect to the first radiator. As shown at (204), the method 200 includes cooling, via the first and second radiators, the hot coolant received from the closed-cycle engine. As shown at (206), the method 200 includes drawing in a flow of air through a grille positioned on a hood of the vehicle. For example, in an embodiment, drawing in the flow of air through the grille positioned on the hood of the vehicle may include operating a fan positioned aft of the first and second radiators and forward of the closed-cycle engine.

As shown at (208), the method 200 includes directing the air across the first and second radiators. As shown at (210), the method 200 includes expelling heat from the cooling of the hot coolant to the air directed across the first and second radiators. As shown at (212), the method 200 includes directing the expelled heat outside of the vehicle to ground. For example, in an embodiment, directing the expelled heat outside of the vehicle to ground may include arranging a radiator surface of the second radiator to face the ground below the vehicle such that the radiator surface is unobstructed with respect to the ground and directing the expelled heat directly from the radiator surface outside of the vehicle to the ground.

Further aspects are provided by the subject matter of the following clauses:

A vehicle, comprising: a hood; a chassis; a radiator assembly mounted to the chassis and being positioned below the hood, the radiator assembly comprising one or more radiators; and a closed-cycle engine mounted to the chassis aft of the radiator assembly, wherein at least one of the one or more radiators is mounted at a non-zero angle with respect to a longitudinal axis of the vehicle.

The vehicle of any preceding clause, wherein the one or more radiators comprise a first radiator and a second radiator, wherein the first radiator is mounted in a first position and the second radiator is mounted in a second position, the first and second positions being different, and wherein the second position is defined by the second radiator being positioned at the non-zero angle.

The vehicle of any preceding clause, wherein the first position is defined by the first radiator being positioned parallel to a vertical axis of the vehicle.

The vehicle of any preceding clause, wherein the first radiator comprises a first radiator surface, the first radiator surface arranged to face an incoming airflow in front of the vehicle.

The vehicle of any preceding clause, wherein the second position is further defined by the second radiator being angled toward the closed-cycle engine.

The vehicle of any preceding clause, wherein the second position of the second radiator defines an obtuse angle with respect to the first position of the first radiator.

The vehicle of any preceding clause, wherein the second radiator comprises a second radiator surface, the second radiator surface arranged to face a ground below the vehicle such that the second radiator surface is unobstructed with respect to the ground.

The vehicle of any preceding clause, further comprising a fan positioned aft of the first and second radiators and forward of the closed-cycle engine so as to draw air into the first and second radiators and down to the ground.

The vehicle of any preceding clause, wherein the second radiator is positioned higher in the vehicle than the first radiator.

The vehicle of any preceding clause, wherein the second position of the second radiator provides for the second radiator to generally correspond to an angle of the hood.

The vehicle of any preceding clause, wherein an end of the second radiator is positioned adjacent to a top end of the first radiator.

A method for cooling a closed-cycle engine of a vehicle, the method comprising: receiving, via first and second radiators of a radiator assembly of the vehicle, hot coolant from the closed-cycle engine, the second radiator being positioned at a non-zero angle with respect to the first radiator; cooling, via the first and second radiators, the hot coolant received from the closed-cycle engine; drawing in a flow of air through a grille positioned on a hood of the vehicle; directing the air across the first and second radiators; expelling heat from the cooling of the hot coolant to the air directed across the first and second radiators; and directing the expelled heat outside of the vehicle to ground.

The method of any preceding clause, wherein drawing in the flow of air through the grille positioned on the hood of the vehicle further comprises: operating a fan positioned aft of the first and second radiators and forward of the closed-cycle engine.

The method of any preceding clause, wherein directing the expelled heat outside of the vehicle to ground further comprises: arranging a radiator surface of the second radiator to face the ground below the vehicle such that the radiator surface is unobstructed with respect to the ground; and directing the expelled heat directly from the radiator surface outside of the vehicle to the ground.

A radiator assembly for a closed-cycle engine of a vehicle, the radiator assembly comprising: a first radiator; and a second radiator, wherein the first radiator is mounted in a first position and the second radiator is mounted in a second position, the first and second positions being different, and wherein the second position is defined by the second radiator being positioned at a non-zero angle with respect to the first position of the first radiator.

The radiator assembly of any preceding clause, wherein the first position is defined by the first radiator being positioned parallel to a vertical axis of the vehicle.

The radiator assembly of any preceding clause, wherein the first radiator comprises a first radiator surface, the first radiator surface arranged to face an incoming airflow in front of the vehicle.

The radiator assembly of any preceding clause, wherein the second position of the second radiator defines an obtuse angle with respect to the first position of the first radiator.

The radiator assembly of any preceding clause, further comprising a fan positioned aft of the first and second radiators so as to draw air into the first and second radiators and down to ground.

The radiator assembly of any preceding clause, wherein the second radiator is positioned higher than the first radiator, and wherein an end of the second radiator is positioned adjacent to a top end of the first radiator.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A vehicle, comprising:
a hood;
a chassis;
a radiator assembly mounted to the chassis and being positioned below the hood, the radiator assembly comprising one or more radiators; and
a closed-cycle engine mounted to the chassis aft of the radiator assembly,
wherein at least one of the one or more radiators is mounted at a non-zero angle with respect to a longitudinal axis of the vehicle.

2. The vehicle of claim 1, wherein the one or more radiators comprise a first radiator and a second radiator, wherein the first radiator is mounted in a first position and the second radiator is mounted in a second position, the first and second positions being different, and wherein the second position is defined by the second radiator being positioned at the non-zero angle.

3. The vehicle of claim 2, wherein the first position is defined by the first radiator being positioned parallel to a vertical axis of the vehicle.

4. The vehicle of claim 2, wherein the first radiator comprises a first radiator surface, the first radiator surface arranged to face an incoming airflow in front of the vehicle.

5. The vehicle of claim 2, wherein the second position is further defined by the second radiator being angled toward the closed-cycle engine.

6. The vehicle of claim 2, wherein the second position of the second radiator defines an obtuse angle with respect to the first position of the first radiator.

7. The vehicle of claim 2, wherein the second radiator comprises a second radiator surface, the second radiator surface arranged to face a ground below the vehicle such that the second radiator surface is unobstructed with respect to the ground.

8. The vehicle of claim 7, further comprising a fan positioned aft of the first and second radiators and forward of the closed-cycle engine so as to draw air into the first and second radiators and down to the ground.

9. The vehicle of claim 2, wherein the second radiator is positioned higher in the vehicle than the first radiator.

10. The vehicle of claim 2, wherein the second position of the second radiator provides for the second radiator to generally correspond to an angle of the hood.

11. The vehicle of claim 2, wherein an end of the second radiator is positioned adjacent to a top end of the first radiator.

12. A method for cooling a closed-cycle engine of a vehicle, the method comprising:
receiving, via first and second radiators of a radiator assembly of the vehicle, hot coolant from the closed-cycle engine, the second radiator being positioned at a non-zero angle with respect to the first radiator;
cooling, via the first and second radiators, the hot coolant received from the closed-cycle engine;
drawing in a flow of air through a grille positioned on a hood of the vehicle;
directing the air across the first and second radiators;
expelling heat from the cooling of the hot coolant to the air directed across the first and second radiators; and
directing the expelled heat outside of the vehicle to ground.

13. The method of claim 12, wherein drawing in the flow of air through the grille positioned on the hood of the vehicle further comprises:
operating a fan positioned aft of the first and second radiators and forward of the closed-cycle engine.

14. The method of claim 12, wherein directing the expelled heat outside of the vehicle to ground further comprises:
arranging a radiator surface of the second radiator to face the ground below the vehicle such that the radiator surface is unobstructed with respect to the ground; and
directing the expelled heat directly from the radiator surface outside of the vehicle to the ground.

15. A radiator assembly for a closed-cycle engine of a vehicle, the radiator assembly comprising:
a first radiator; and
a second radiator,
wherein the first radiator is mounted in a first position and the second radiator is mounted in a second position, the first and second positions being different, and
wherein the second position is defined by the second radiator being positioned at a non-zero angle with respect to the first position of the first radiator.

16. The radiator assembly of claim 15, wherein the first position is defined by the first radiator being positioned parallel to a vertical axis of the vehicle.

17. The radiator assembly of claim 15, wherein the first radiator comprises a first radiator surface, the first radiator surface arranged to face an incoming airflow in front of the vehicle.

18. The radiator assembly of claim 15, wherein the second position of the second radiator defines an obtuse angle with respect to the first position of the first radiator.

19. The radiator assembly of claim 18, further comprising a fan positioned aft of the first and second radiators so as to draw air into the first and second radiators and down to ground.

20. The radiator assembly of claim 15, wherein the second radiator is positioned higher than the first radiator, and wherein an end of the second radiator is positioned adjacent to a top end of the first radiator.
